(19) United States
(12) Patent Application Publication
(10) Pub. No.: US 2008/0161144 A1
(43) Pub. Date: Jul. 3, 2008

(54) Chain transmission device

(75) Inventors: Akira Hirai, Osaka (JP); Shunji Sakura, Osaka (JP); Shigenobu Sugasawa, Osaka (JP); Junya Kurohata, Osaka (JP); Takeshi Ogawa, Osaka (JP)

Correspondence Address: HOWSON AND HOWSON, SUITE 210, 501 OFFICE CENTER DRIVE, FT WASHINGTON, PA, 19034, US

(73) Assignee: Tsubakimoto Chain Co., Osaka (JP)

(21) Appl. No.: 11/982,928

(22) Filed: Nov. 6, 2007

(30) Foreign Application Priority Data
Dec. 27, 2006 (JP) 2006-353489

(51) Int. Cl. F16H 55/30; F16H 7/06

(52) U.S. Cl. 474/141

(57) ABSTRACT

In a chain transmission a standard ISO roller chain meshes with a modified sprocket having a root diameter larger than the root diameter of a standard sprocket designed for use with the standard chain. The angular tooth pitches can be either of two kinds. In a first version, the sprocket has two irregularly distributed tooth pitches, θ−Δθ and θ+2Δθ, there being two tooth pitches θ−Δθ for each tooth pitch θ+2Δθ. In a second version, the sprocket has three angular tooth pitches, θ−Δθ, θ, and θ+Δθ, in equal numbers, also distributed irregularly.

### CROSS-REFERENCE TO RELATED APPLICATION

This application claims priority from Japanese patent application 2006-353489, filed Dec. 27, 2006. The disclosure of Japanese patent application 2006-353489 is incorporated by reference.

### FIELD OF THE INVENTION

The invention relates to a chain transmission in which noises, generated when a roller of a standard roller chain or a bushing of a standard rollerless bushing chain engages with a sprocket tooth, are reduced, and in which the roller or bushing smoothly disengages the sprocket.

### BACKGROUND OF THE INVENTION

A chain transmission in which a chain is engaged with a driving sprocket and one or more driven sprockets has been widely used as a timing transmission in automobile engines for driving the valve-operating cam or cams from the engine crankshaft.

Recent demand for higher power automobile engines, coupled with public consciousness of environmental problems, has led to the development of engines that produce high levels of noise and to efforts toward reducing that noise. For example, in a high power engine operating at a high rotational speed, the load on the timing transmission and its contribution to the overall noise produced by the engine become significant. The principal source of timing transmission noise is the engagement sound generated as the chain engages the sprockets. Attempts have been made to reduce noise and vibration by utilizing vibration proofing materials to absorb radiated sound. Vibration proofing rubber has also been used to reduce noise. However, as the load on the transmission increases, the tension in the chain also increases, resulting in greater levels of engagement sounds. Vibration proofing materials have not proven capable of suppressing these noises adequately.

Roller chains, rollerless bushing chains, and sprockets, used in chain transmissions are defined in International Standard (ISO 606: 1994(E)) and in Japanese Industrial Standards (JIS B 1801-1997). The International Standard (ISO 606: 1994 (E)) defines tooth forms of chains and sprockets (the “ISO tooth form”), and Japanese Industrial Standards (JIS B 1801-1997) define tooth forms of chains and sprockets (S-tooth forms and U-tooth forms). Both International Standard (ISO 606: 1994(E)) and Japanese Industrial Standards (JIS B 1801-1997) are here incorporated by reference. Copies of the relevant parts of both standards are attached. Chain transmissions generally use standard roller chains and standard sprockets, defined in ISO 606: 1994 (E) or JIS B 1801-1997.

As used herein, the term “standard chain” means a chain as defined in International Standard ISO 606: 1994 (E), or in Japanese Industrial Standards JIS B 1801-1997, and the terms “standard sprocket” and “standard tooth form” refer respectively to sprockets and sprocket teeth conforming to the ISO tooth form, or the S-tooth form or U-tooth form according to the above-mentioned Japanese Industrial Standards.

FIGS. 8 and 9 show schematically a chain transmission comprising a standard roller chain 80 and a standard sprocket 90 having an ISO tooth form. FIG. 9 is an enlarged view of a portion labeled “IX” in FIG. 8.

The ISO tooth forms shown in FIGS. 8 and 9 are defined by the following expressions from ISO 606: 1994 (E).

d=p/sin(180°/z)

df=d−d1

dc=df (for a sprocket having an even number of teeth)

dc=d cos(90°/z)−d1 (for a sprocket having an odd number of teeth)

re(max)=0.12d1(z+2)

r1(min)=0.505d1

re(min)=0.008d1(z2+180)

r1(max)=0.505d1+0.069(d1)^{1/3}

where
p is the chain pitch,
d is the pitch circle diameter,
d1 is the roller outer diameter,
df is the diameter of the tooth gap bottom circle (root diameter),
dc is the caliper diameter of the sprocket
re (max) is the maximum value of the arc of the tooth head,
ri (min) is the minimum value of the radius of the arc of the tooth gap bottom,
re (min) is the minimum value of the arc of the tooth head,
ri (max) is the maximum value of the radius of the arc of the tooth gap bottom,
and
z is the number of sprocket teeth.

The Japanese Industrial Standard tooth form differs in some respects from the ISO tooth form. However, the root diameter, df=d−d1, is the same in both cases. In FIG. 8, the distance pa is the chordal pitch of the sprocket, which, in the case of a sprocket having the standard tooth form, is equal to the chain pitch p.

As apparent from the above expressions, in the standard sprocket 90, shown in FIG. 9, the profile of the tooth gap bottom 93 is in the form of an arc having a radius ri, which is slightly larger than the radius (d1/2) of the roller 82, and the tooth surface 92 is in the form of an arc having a radius re. Tooth surfaces 92 are continuous with the tooth gap bottom portion 93 on both sides of the tooth gap. The diameter df of the tooth gap bottom circle (also referred to as the “root diameter”) is equal to the difference between the pitch circle diameter d and the roller outer diameter d1. Furthermore, the diameter df of the tooth gap bottom circle is substantially the same as the difference between the pitch circle diameter d and twice the radius ri of the arc of the tooth gap bottom.

The standard roller chain is composed of a series of inner and outer links arranged alternately. Each inner link is composed of two inner plates and two bushings. The ends of each bushing are press-fit into bushing holes in the respective inner plates. A roller, having an outer diameter d1 is rotatably fitted on the outer circumference of each bushing. Each outer link is composed of two outer link plates and two connecting pins. The ends of each connecting pin are press-fit into pin holes in the respective outer plates. The outer plates of each link are arranged in overlapping relationship with the inner plates of two inner links, and each pin of an outer link extends through a bushing of an inner link so that the inner and outer links are connected flexibly.

The standard roller chain has a uniform chain pitch p (FIG. 8), which is the distance between the centers of its successive rollers.

FIG. 8 shows only the rollers 82 of the standard roller chain 80, the bushings, inner plates, inner links, connecting pins, outer plates and outer links being omitted. The standard roller chain 80 shown in FIG. 8 has a uniform chain pitch p (i.e., the distance between the centers of the respective rollers 82).

The standard sprocket 90 shown in FIGS. 8 and 9 is a driving sprocket having eighteen teeth. Since a tooth form pitch angle θ is determined by the formula θ=360°/z, the tooth form pitch angle θ of this sprocket is 20°. The chordal tooth form pitch pa corresponds to the tooth form pitch angle θ, and the standard sprocket 90 has uniform tooth pitch angles θ of 20° and a uniform chordal tooth form pitch pa.

As shown in FIGS. 8 and 9, in a standard sprocket, for each pair of teeth, tooth surfaces, which are continuous with a tooth gap bottom, are symmetrical with respect to a center line X extending radially from the rotational center O of the sprocket through the center of the tooth gap bottom. The respective center lines X intersect a pitch circle pc at intersections a, and the tooth form pitch angle θ is the angle formed by adjacent center lines X extending through adjacent intersections a on the pitch circle. Thus, the tooth form pitch angle θ is determined by the number z of teeth of the sprocket by the formula θ=360°/z. The tooth form pitch pa is the distance between successive intersection points a. Therefore, the tooth, form pitch pa is a chordal distance corresponding to the tooth form pitch angle θ. Since the standard sprocket has equal tooth form pitch angles θ, equal chordal tooth form pitches pa are arranged in a circumferential direction along the pitch circle pc. The chordal tooth form pitch pa is equal to the chain pitch p.

A low noise roller chain transmission has been provided, which comprises a roller chain and a sprocket including a number of identically shaped teeth. The outer diameter of each roller is made larger than the standard size, so that, when the roller engages a sprocket tooth, it abuts a pair of adjacent, opposed tooth surfaces, while a space is left between the roller and the tooth gap bottom. The tooth gap bottom is in the form of an arc having a diameter slightly smaller than the outer diameter of the roller. As explained in Japanese Patent Publication No. Hei 7-18478, a small angle is formed between a line tangent to the roller at the position where the roller abuts a tooth surface, and a line connecting the center of the roller and the center of the sprocket. The roller, the tooth surface, or both, are elastically deformed when the roller seats on the tooth gap bottom or comes into sliding contact with the tooth surface and moves toward the tooth gap bottom.

When the standard sprocket 90 is rotated clockwise, at the beginning of engagement of a roller 82 with the sprocket, the roller moves, relative to the sprocket, about the center O1 of a preceding roller 82 which is already seated on a tooth gap bottom. This relative movement takes place in an arc centered on center O1, and having a radius equal to the chain pitch p. The roller collides with the center of tooth gap bottom at a substantially right angle. As a result, the kinetic energy of the roller 82 is transmitted to the tooth gap bottom without being buffered at the beginning of engagement. The collision results in vibration and noise at the beginning of engagement.

Since the chordal pitch pa of the tooth form of the standard sprocket 90 is the same as the pitch p of the standard roller chain 80, each following roller 82 abuts a tooth bottom at the same position t at the beginning of engagement. Therefore, all the engagement impacts occur at regular intervals. Moreover, vibration and noise increase as the number of sprocket teeth is increased.

In the low noise chain transmission described in Japanese patent publication No. Hei 7-18478, the elastic deformation of the roller and/or the tooth surface, reduces the engagement shock so that noise is reduced. On the other hand, since the wedging of the roller between opposed tooth surfaces, prevents smooth disengagement of the roller from the sprocket.

Accordingly, an object of this invention is to provide a chain transmission in which vibration and noise generated when a standard chain engages a sprocket is reduced, and in which the standard chain smoothly disengages from the sprocket.

### SUMMARY OF THE INVENTION

The chain transmission according to the invention comprises a standard roller chain or a standard rollerless bushing chain and a sprocket engageable in driving or driven relationship with the chain. The sprocket has at least two different tooth form pitch angles, arranged irregularly along the circumferential direction of the sprocket's pitch circle, and the root diameter of the sprocket is larger than the root diameter of a standard sprocket designed for use with said standard chain.

In one preferred embodiment, the tooth form pitch angles are θ−Δθ, θ−Δθ and θ+2Δθ, θ being the tooth form pitch angle of said standard sprocket. In this case, there are two tooth form pitch angles, θ−Δθ and θ+2Δθ, and twice as many tooth form pitch angles θ−Δθ as there are tooth form pitch angles θ+2Δθ. In another preferred embodiment, the tooth form pitch angles are θ−Δθ, θ, and θ+Δθ, in equal numbers In either case, the tooth form pitch angles are preferably arranged irregularly along the circumferential direction of the sprocket's pitch circle.

When the sprocket has at least two different tooth form pitch angles, arranged irregularly along the circumferential direction of the sprocket's pitch circle, and the root diameter of the sprocket is larger than the root diameter of a standard sprocket designed for use with the standard chain, the following effects are obtained.

First, the kinetic energy at the engagement of the roller or bushing with the sprocket is reduced, and the engagement sound is reduced as a result.

Second, since the timing of the impact of the rollers or bushings with the sprocket is irregular, noises having an order determined by the number of sprocket teeth are reduced. Furthermore, since the difference between the overall sounds and each rotational order sound, i.e. each periodic sound, is large, the rotational order sounds become less noticeable.

A preceding roller or bushing of the standard chain first abuts a tooth surface of a sprocket on the back side thereof with reference to the direction of rotation. At the start of engagement of the following roller or bushing with the sprocket, the following roller or bushing abuts the back side of a next tooth substantially in the direction of a tangent line. Shock due to relative movement of the preceding roller or bushing is therefore small. Furthermore, since the shock at abutment is small at the start of engagement, the noise due to shock is reduced.

At disengagement of the roller or bushing from the sprocket, a preceding roller or bushing pivotably moves relative to the following roller or bushing about the center of the following roller or bushing in an arcuate path having a radius equal to the chain pitch of the standard chain. Thus, the path of the following roller is arcuate when the sprocket is the reference. Since the preceding roller or bushing initially abuts the front surface of a tooth in the direction of its rotation, the roller or bushing can easily move from its abutment position. Therefore, the preceding roller or bushing can smoothly disengage from the sprocket without being wedged between opposed tooth surfaces.

### BRIEF DESCRIPTION OF THE DRAWINGS

FIG. 1 is an elevational view of a portion of a sprocket showing tooth forms according to first and second examples the invention;

FIG. 2 is an elevational view of a portion of a sprocket showing tooth forms according to third and fourth examples the invention;

FIG. 3 is an elevational view of a portion of a sprocket showing tooth forms according to fifth and sixth examples the invention;

FIG. 4 is an elevational view of a portion of a sprocket showing tooth forms according to seventh and eighth examples the invention;

FIG. 5 is an elevational view showing the engagement of a sprocket and a standard roller chain in a chain transmission according to all eight examples the invention;

FIG. 6 is an elevational view showing the engagement of a standard roller chain and a sprocket in a chain transmission according to the first, third, fifth and seventh examples of the invention;

FIG. 7 is an elevational view showing the engagement of a standard roller chain and a sprocket in a chain transmission according to the second, fourth, sixth and eighth examples of the invention;

FIG. 8 is an elevational view showing a conventional chain transmission using a standard roller chain and a standard sprocket;

FIG. 9 is an enlarged view of a portion, labeled “IX”, of the transmission of FIG. 8; and

FIG. 10 is a table showing parameters of eight examples of the invention and the standard ISO sprocket tooth form.

### DETAILED DESCRIPTION OF THE PREFERRED EMBODIMENTS

In a chain transmission incorporating a standard roller chain or a standard rollerless bushing chain, if a sprocket of the transmission has at least two different tooth form pitch angles, arranged irregularly around the pitch circle, and the root diameter of the sprocket is larger than the root diameter of a standard sprocket, vibration and noise generated when the standard chain engages the sprocket are reduced, and the standard chain disengages from the sprocket smoothly.

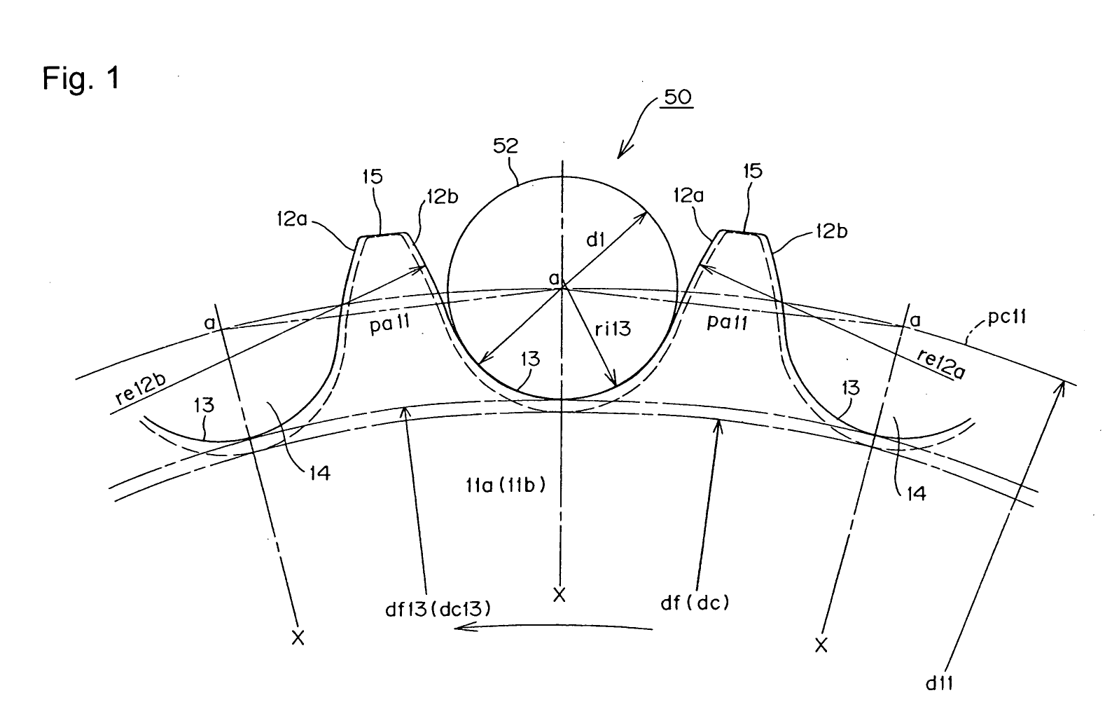

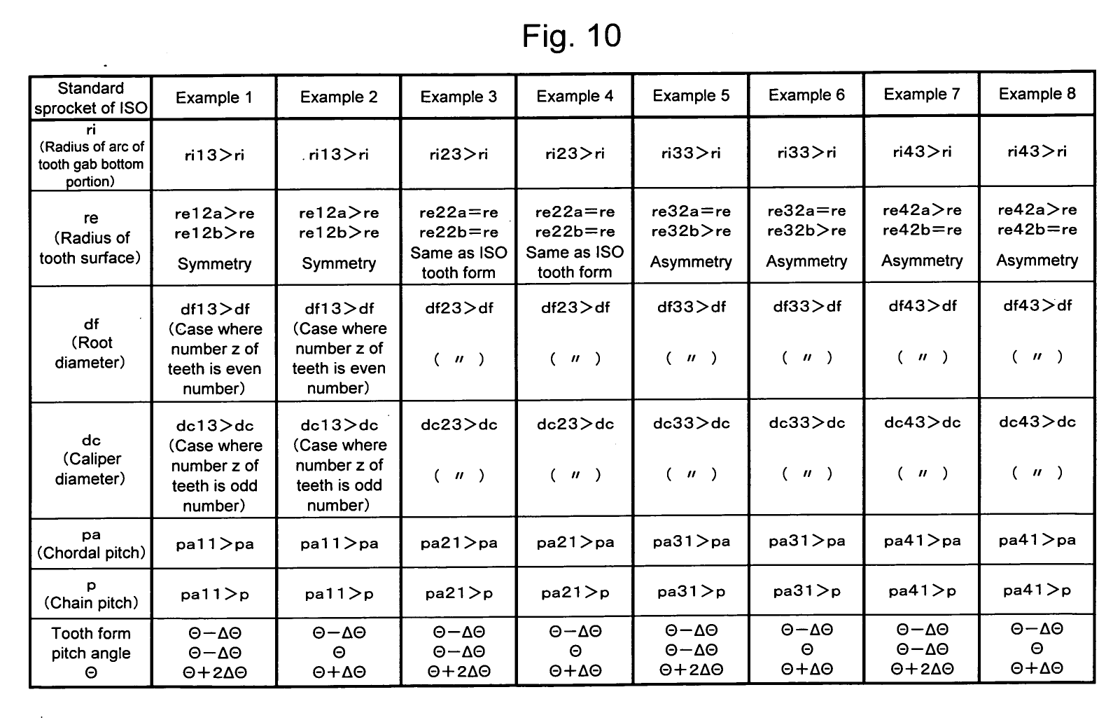

In the sprocket of a preferred chain transmission according to the invention, a plurality of sprocket teeth are separated from one another by tooth gaps. Facing surfaces of adjacent teeth are continuous with a tooth gap bottom. In the tooth form of the sprocket, the root diameter of the tooth gap bottom circle is larger than the root diameter of a standard sprocket, that is, a sprocket in which the teeth conform to the ISO tooth form. The teeth of the sprocket have at least two different tooth form pitch angles, and the differing tooth form pitch angles are arranged irregularly along the circumferential direction of the pitch circle p. Eight examples will be described with reference to FIGS. 1 to 7. Sprocket parameters used in FIGS. 1 to 7 are shown in FIG. 10.

FIG. 1 shows a part of a tooth form of a sprocket 11a, and a roller 52 of a standard roller chain 50, in a chain transmission according to a first example of the invention.

In the sprocket 11a, facing tooth surfaces 12a and 12b of teeth 15 form a plurality of tooth gaps 14 which are continuous with tooth gap bottoms 13. FIG. 1 shows a standard ISO tooth form in a broken line for comparison.

In the tooth form of the sprocket 11a, a surface 12a, which is a front surface in the rotational direction of the sprocket, and a tooth surface 12b, which is a back surface are symmetrical with respect to a center line X of the tooth gap bottom, the center line being formed by connecting the rotational center of the sprocket to the center of the tooth gap bottom. The tooth surface 12a and the tooth surface 12b are respectively formed of arcs each having a convex shape. The arcs forming the tooth surfaces 12a and the tooth surfaces 12b have radii re12a and re12b respectively, these radii being larger than the radius re of the arc of the tooth surface in a sprocket having a standard ISO tooth form. That is, re12a>re and re12b>re. The surface 12a and the tooth surface 12b are smoothly continuous with the tooth gap bottom 13.

The tooth gap bottom 13 is in the form of an arc having a radius ri13 and its center, positioned radially outward from the tooth gap bottom, on center line X. Radius ri13 is larger than the radius ri of the arc of the tooth gap bottom in a standard ISO tooth form. That is, ri13>ri.

As mentioned previously, the root diameter df13 (that is, the diameter of the tooth gap bottom) is larger than the root diameter df of the Standard ISO tooth form. That is, df13>df. When the number of sprocket teeth is odd, the caliper diameter dc13, differs from the root diameter df13. However, in this case, the caliper diameter is larger than the caliper diameter dc of the Standard ISO tooth form. That is, dc13>dc.

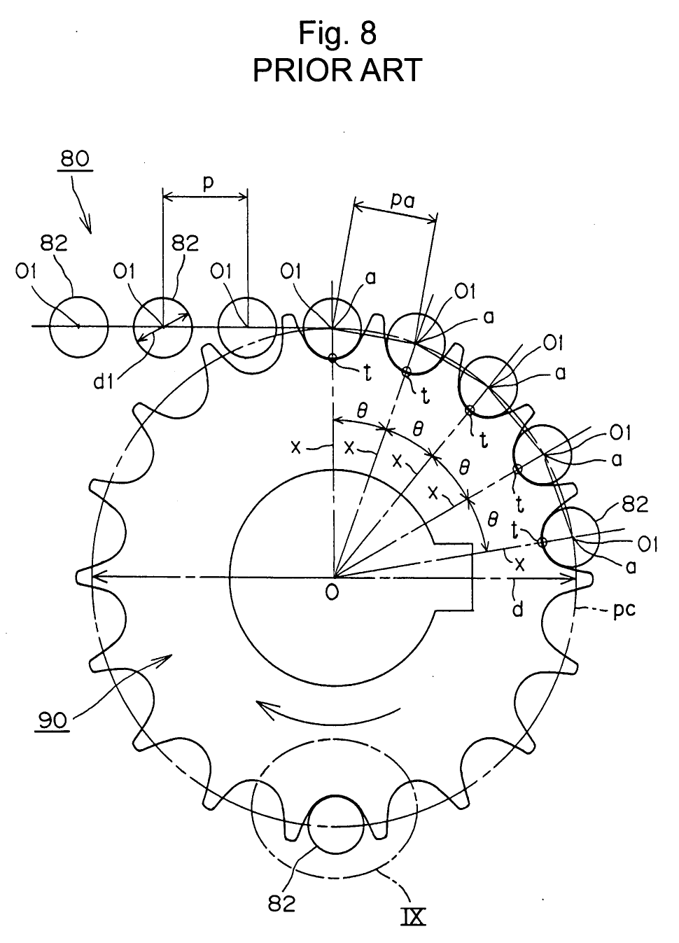

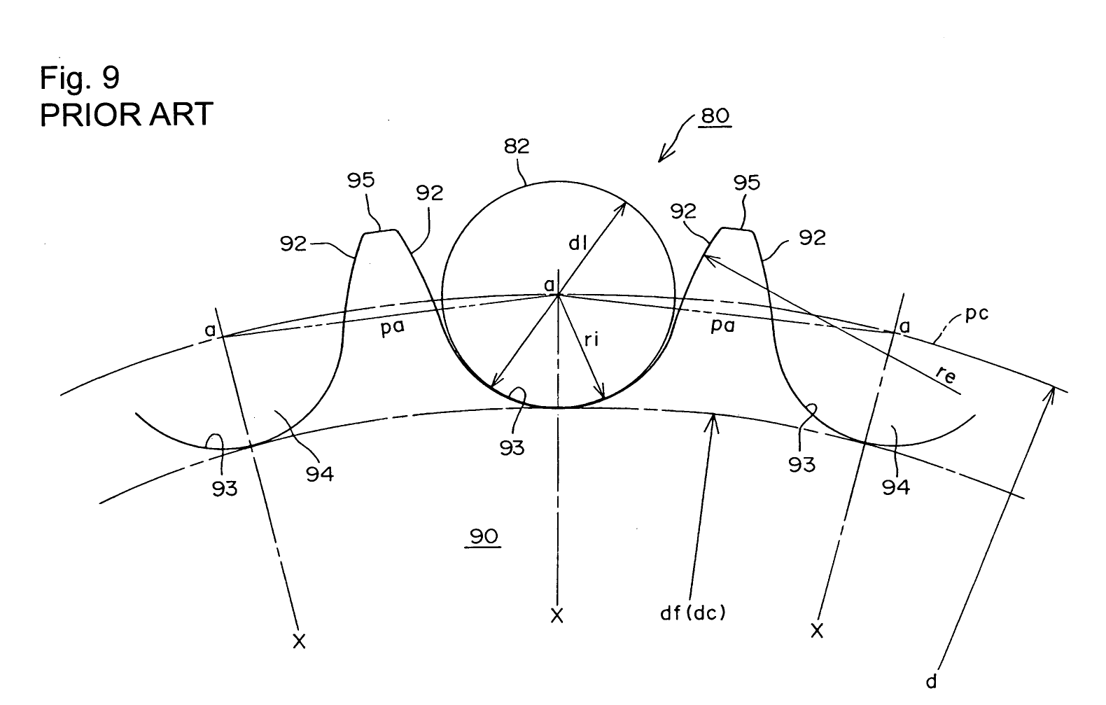

Because the root diameter df13 is greater than the root diameter df of the Standard ISO tooth form, the chordal pitch pall of the sprocket 11a (that is, the distance between intersection points a of the pitch circle pc11 and the center lines X of the tooth gap bottoms) is larger than the chordal pitch pa of the standard sprocket, as illustrated in FIGS. 8 and 9). That is, pa11>pa.

The chordal pitch pa of a standard sprocket having a Standard ISO tooth form is equal to the chain pitch p of a standard roller chain adapted to mesh with the sprocket, the chain pitch p being the distance between the centers of the rollers. On the other hand, the chordal pitch pall of the sprocket according to the invention is larger than the chain pitch p of the standard roller chain 50. That is, pa11>p.

The sprocket 11a has two kinds of different tooth form pitch angles θ−Δθ and θ+2Δθ. The tooth form pitch angle θ−Δθ is smaller than a standard pitch angle θ by an angle Δθ, and a tooth form pitch angle θ+2Δθ is larger than the standard pitch angle θ by two times the angle Δθ. In order to allow engagement of the chain rollers with the sprocket teeth, Δθ must not be greater than ¼ the standard pitch angle θ (that is Δθ≦θ/4). Specifically, if the sprocket 11a has eighteen teeth, that is z=18, the standard pitch angle θ is 20° from the expression θ=360°/z, and Δθ≦5° based on the formula Δθ≦θ/4. Preferably, to achieve smooth engagement, the cumulative pitch of three consecutive pitch angles should be 3θ, especially if Δθ is large.

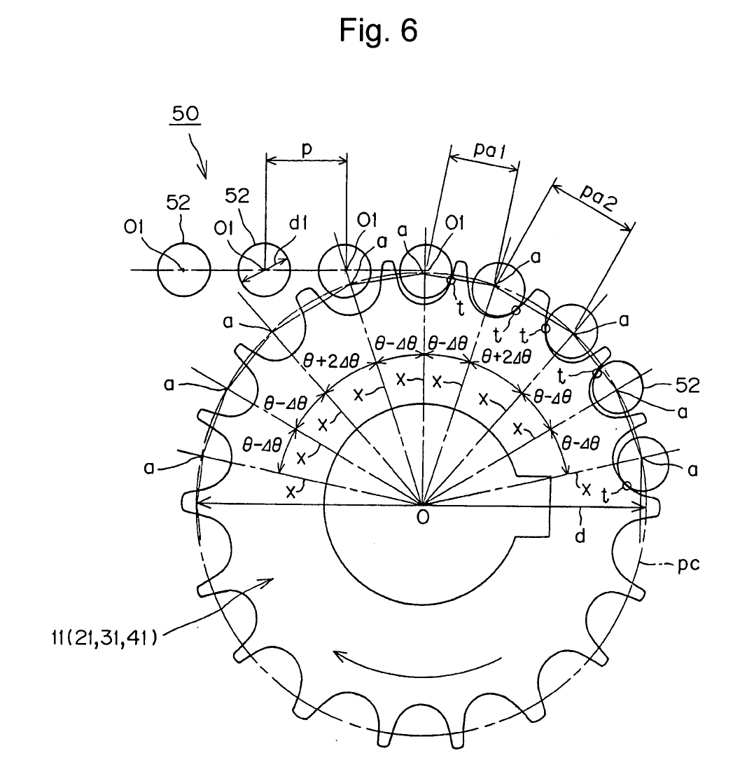

In the sprocket 11a, as shown in FIG. 6, these two kinds of tooth form pitch angles, θ−Δθ and θ+2Δθ, are arranged irregularly along the circumferential direction of the pitch circle, with two tooth form pitch angles θ−Δθ for each tooth form pitch angle θ+2Δθ. The total of the two kinds of tooth pitch angles, θ−Δθ and θ+2Δθ, is 360°.

FIG. 6 shows engagement between a standard roller chain 50 and a sprocket according to the first example of the invention. The tooth form pitches pa1 and pa2 correspond to the chordal pitch pall in FIG. 1.

As the sprocket rotates, a roller that follows a roller that has already seated in a tooth gap, moves in an arc relative to the preceding roller, the arc being centered on the center O1 of the seated roller and having a radius equal to the chain pitch p. The roller that follows the already seated roller abuts a tooth surface in a direction substantially tangential to the tooth surface. Thus, the kinetic energy of the following roller is buffered so that there is very little abutment shock, and the engagement noise is reduced.

The standard roller chain 50 has a uniform chain pitch p. Since the sprocket has two different tooth form pitches pa1 and pa2, which are chordal distances corresponding to two different tooth form pitch angles. Since these tooth form pitches pa1 and pa2 are arranged irregularly along the circumferential direction of the pitch circle pc, with two tooth form pitches pa1 and for each tooth form pitch pa2 the abutment position t of each roller 52 onto a sprocket tooth varies. Thus, the timing of the collisions of the rollers with the sprocket teeth is not uniform, and the magnitude of vibration and noise are reduced, compared to the vibration and noise produced in a conventional transmission where the vibration is uniform, and of an order determined by the number of teeth.

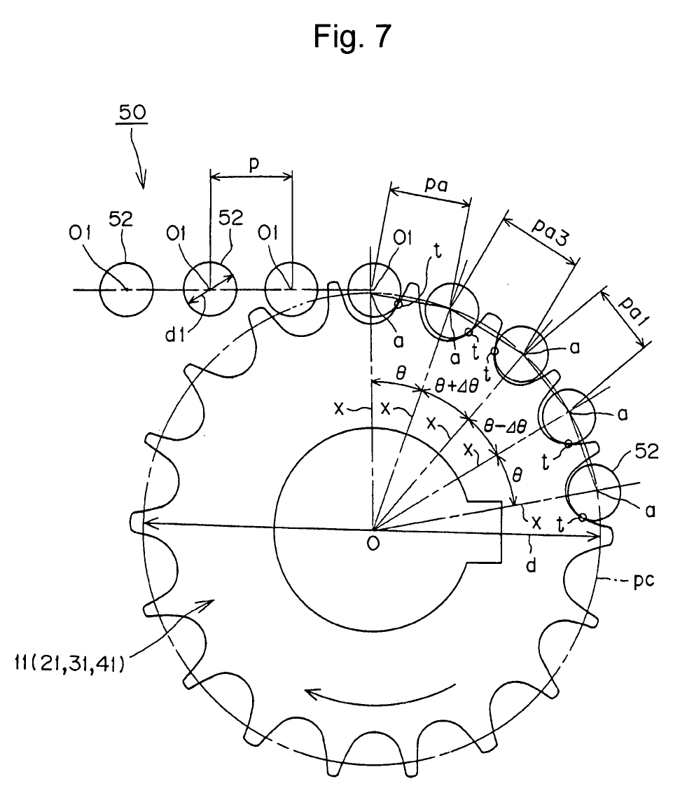

In the second example, depicted in FIG. 7, the tooth form is the same as that of the first example, shown in FIG. 1. However, in the second example, the tooth form pitch angles of the sprocket are different from those in the first example in that the sprocket of the second example has three different tooth form pitch angles: θ (the standard pitch angle), θ+Δθ and θ−Δθ. The tooth form pitch angle θ+Δθ is larger than the standard pitch angle θ by an angle Δθ, and the pitch angle θ−Δθ is smaller than the standard pitch angle θ by an angle Δθ. As mentioned above, Δθ must be ¼ or less the standard pitch angle θ (that is, Δθ≦θ/4). With this limitation, the pitch angles are within a range that allows proper engagement of the rollers with the sprocket. If the sprocket has eighteen teeth, a standard pitch angle θ is 20°, based on the expression θ=360°/z, and Δθ≦5°, based on the formula Δθ<θ/4.

The total of the three kinds of tooth pitch angles θ, θ+Δθ and θ−Δθ is 360°. Here, as in the case of the embodiment shown in FIG. 6, the cumulative pitch of three consecutive pitch angles is preferably 30, especially if Δθ is large.

In the sprocket shown in FIG. 7, these three tooth form pitch angles θ (the standard pitch angle), θ+Δθ and θ−Δθ, are in equal numbers, and arranged irregularly along the circumferential direction of the pitch circle pc. Here, as in the first example, the tooth form pitch pa is a chordal distance corresponding to the standard tooth pitch angle θ. Tooth form pitch pa3 is a chordal distance corresponding to a tooth form pitch angle θ+Δθ, and tooth form pitch pa1 is a chordal distance corresponding to a tooth form pitch angle θ−Δθ. Therefore, the sprocket 11b has three different tooth form pitches, pa, pa3 and pa1, arranged irregularly along the circumferential direction of the pitch circle pc.

The standard roller chain 50 has a uniform chain pitch p. However the sprocket according to the second example has three different tooth form pitch angles, θ, θ−Δθ and θ+Δθ. These tooth form pitch angles, θ, θ−Δθ and θ+Δθ, are arranged, in equal numbers, irregularly along the circumferential direction of the pitch circle pc When the sprocket is rotated, a roller becomes seated in the tooth gap at an abutment position t. A roller that follows a roller that has already seated in a tooth gap moves in an arc relative to the preceding roller, the arc being centered on the center O1 of the seated roller and having a radius equal to the chain pitch p. The roller that follows the already seated roller abuts a tooth surface in a direction substantially tangential to the tooth surface. Thus, the kinetic energy of the following roller is buffered so that there is very little abutment shock. Therefore, the engagement noise is reduced.

The standard roller chain 50 has a uniform chain pitch p, and the sprocket has three kinds of tooth form pitches pa, pa1 and pa3, which are chordal distances corresponding to two different tooth form pitch angles. Since these tooth form pitches pa, pa1 and pa3, are arranged irregularly along the circumferential direction of the pitch circle pc, the abutment position t of each roller 52 onto a sprocket tooth varies. Thus, as in the first example, the timing of the collisions of the rollers with the sprocket teeth is not uniform, and the magnitude of vibration and noise are reduced, compared to the vibration and noise that is produce in a conventional transmission, where the vibration is uniform and of an order determined by the number of teeth.

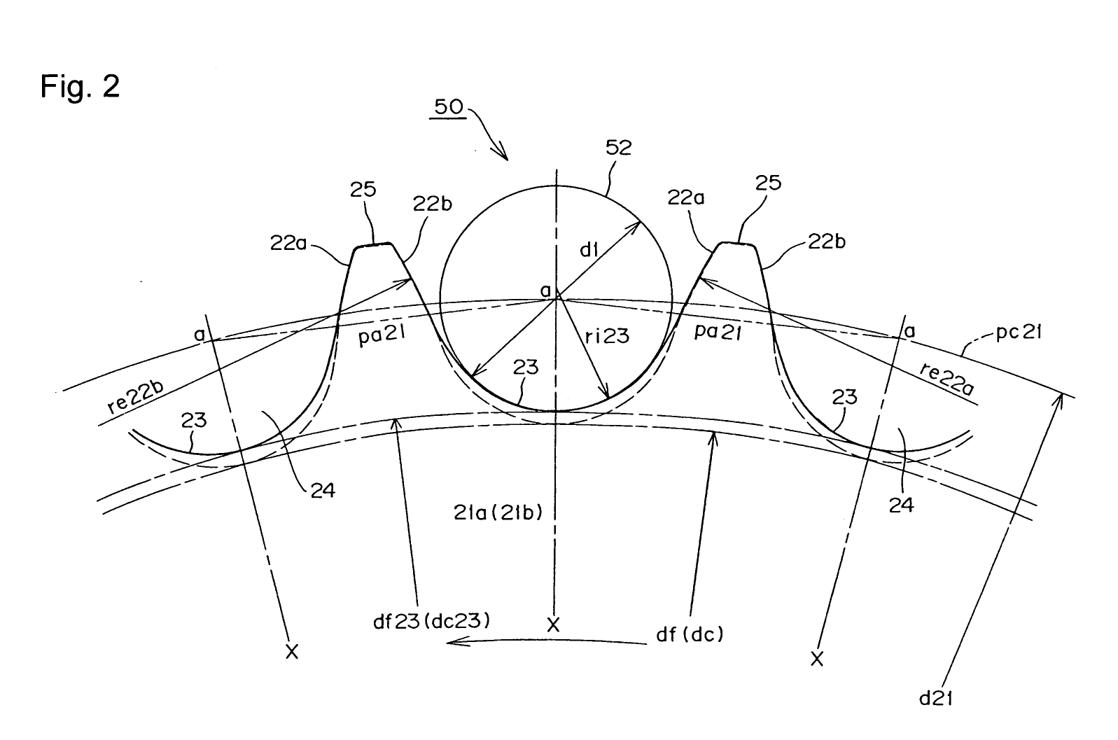

In a third example of the invention, the sprocket has a tooth form as shown in FIG. 2. The sprocket 21a has a plurality of teeth 25 separated by tooth gaps 24, in which facing tooth surfaces 22a and 22b are continuous with a tooth gap bottom 23. FIG. 2 also shows a standard ISO tooth form in a broken line for comparison.

In the tooth form of the sprocket shown in FIG. 2, a tooth surface 22a of the sprocket 21a on a front side in the rotational direction and a tooth surface 22b of the sprocket 21a on a back surface in the rotational direction are symmetrical with respect to a center line X of the tooth gap bottom extending radially from the rotational center (not shown) of the sprocket to the center of the tooth gap bottom. The tooth surface 22a and the tooth surface 22b are respectively in the form of convex arcs having the identical radii re22a and re22b, both of which are identical to the radius re of the arc of the tooth surface of the standard ISO tooth form. That is, re22b=re. The tooth surfaces 22a and 22b are smoothly continuous with the tooth gap bottom 23.

The tooth gap bottom 23 is in the form of an arc having its center on center line X of the tooth gap bottom portion. The arc forming the tooth gap bottom portion 23 has a radius ri23 larger than the radius ri of the arc-shaped tooth gap bottom in a standard ISO tooth form. That is, ri23>ri.

The center of the arc of the tooth gap bottom is positioned farther outward from the center of the arc of the tooth gap bottom in a standard ISO tooth form. Therefore, the root diameter df23 is larger than the root diameter df of the Standard ISO tooth form. That is, df 23>df. Furthermore, when the number of teeth 21a is odd, the caliper diameter dc23 is larger than the caliper diameter dc of the standard ISO tooth form. That is, dc23>dc.

Because the root diameter df23 is greater than the root diameter df of the standard ISO tooth form, the chordal pitch pall of the sprocket 21a (that is, the distance between intersections a of the pitch circle pc21 and the center lines X of the tooth gap bottoms) is greater than the chordal pitch pa of a standard sprocket. That is, pa21>pa.

Since a standard sprocket is adapted to the standard roller chain 50, the chordal pitch pa of a standard sprocket having a standard ISO tooth form is equal to the chain pitch p of a standard roller chain 50 (that is a distance between the centers O1 of rollers 52). On the other hand, the chordal pitch pall of the sprocket 21a is larger than the chain pitch p of the standard roller chain 50. That is, pa21>p.

The tooth form pitch angles of the sprocket 21a used in the third example are the same as the tooth form pitch angles in the first example.

In a chain transmission according to a fourth example of the invention, the tooth form of the sprocket 21b is the same as the tooth form of the third example, and the tooth form pitch angles of the sprocket 21b are the same as the tooth form pitch angles of the second example.

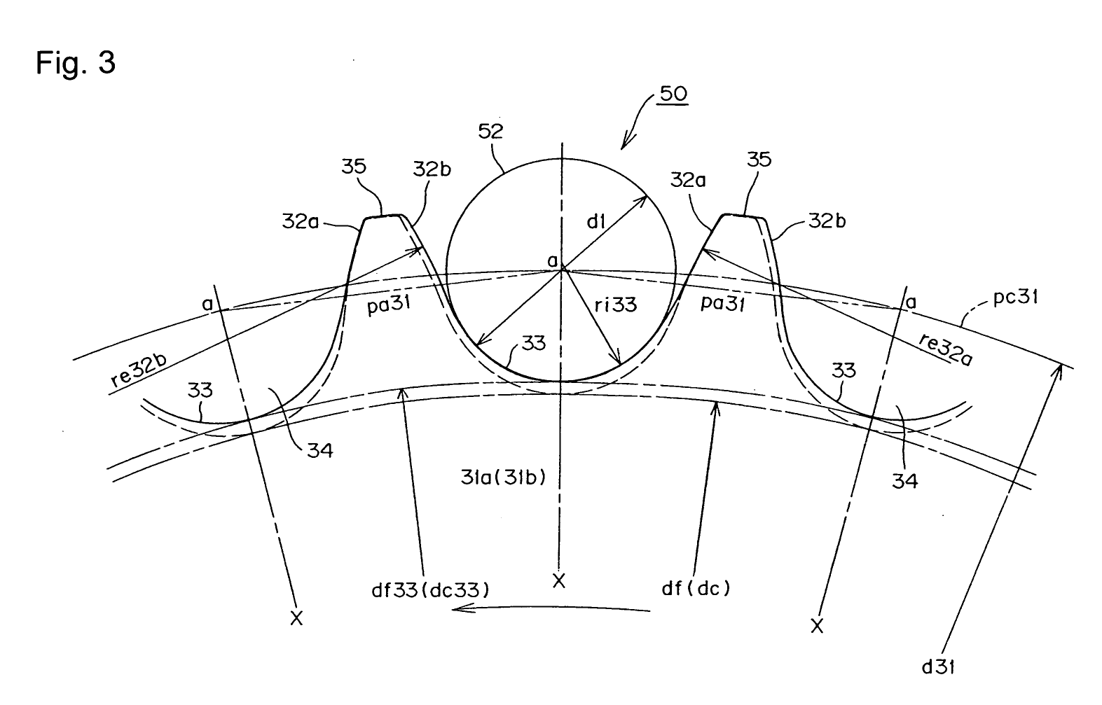

In a chain transmission device according to a fifth example of the invention, as shown in FIG. 3, a sprocket 31a is in mesh with a standard roller chain 50.

In the sprocket 31a, a tooth surface 32a and a tooth surface 32b, which face each other, are separated by a tooth gap 34 and continuous with the tooth gap bottom 33. FIG. 3 shows a standard ISO tooth form in a broken line for the comparison.

As shown in FIG. 3, the tooth surface 32a on the side of each tooth that is a front side with reference to the rotational direction of the sprocket, and a tooth surface 32b on the back side of each tooth are asymmetric with respect to the center line X of a tooth gap bottom. The tooth surface 32a is in the form of a convex arc. The arc forming the tooth surface 32a has a radius re32a, which is the same as the radius re of the arc-shaped tooth surface of the Standard ISO tooth form of a sprocket adapted to cooperate with the standard roller chain 50. That is, re32a=re. On the other hand, the convex arcuate tooth surface 32b has a radius re32b larger than the radius re of an arc shaped tooth surface of the standard ISO tooth form. That is, re32a>re. And the tooth surface 32a and the tooth surface 32b are smoothly continuous at the tooth gap bottom 33.

The tooth gap bottom 33 is in the form of an arc having its center on the center line X of the tooth gap bottom. The arc of the tooth gap bottom 33 has a radius ri33, which is larger than the radius ri of the tooth gap bottom in a standard ISO tooth form. That is, ri33>ri.

The center of the arc having radius ri33 is located radially outward with respect to the rotational center of the sprocket from the location of the center of the arc of the tooth gap bottom of the standard ISO tooth form. Therefore, the root diameter df33 is larger than the root diameter df of the Standard ISO tooth form. That is, df33>df. Furthermore, when the number of teeth 21a is odd, the caliper diameter dc23 is larger than the caliper diameter dc of the standard ISO tooth form. That is, dc33>dc.

Because the root diameter df33 is greater than the root diameter df of the standard ISO tooth form, the chordal pitch pall of the sprocket 21a (that is, the distance between intersections a of the pitch circle pc31 and the center lines X of the tooth gap bottoms) is greater than the chordal pitch pa of a standard sprocket. That is, pa31>pa.

Since a standard sprocket is adapted to the standard roller chain 50, the chordal pitch pa of a standard sprocket having a standard ISO tooth form is equal to the chain pitch p of a standard roller chain 50 (that is, a distance between the centers O1 of rollers 52). On the other hand, the chordal pitch pa31 of the sprocket 31a is larger than the chain pitch p of the standard roller chain 50. That is, pa31>p. The tooth form pitch angles of the sprocket 31a according to the fifth example are the same as the tooth form pitch angles of the first example.

In the sixth example of the invention the sprocket tooth form, shown in FIG. 3, is the same as in the fifth example. The tooth form pitch angles of the sprocket 31b are the same as the tooth form pitch angles of the second example.

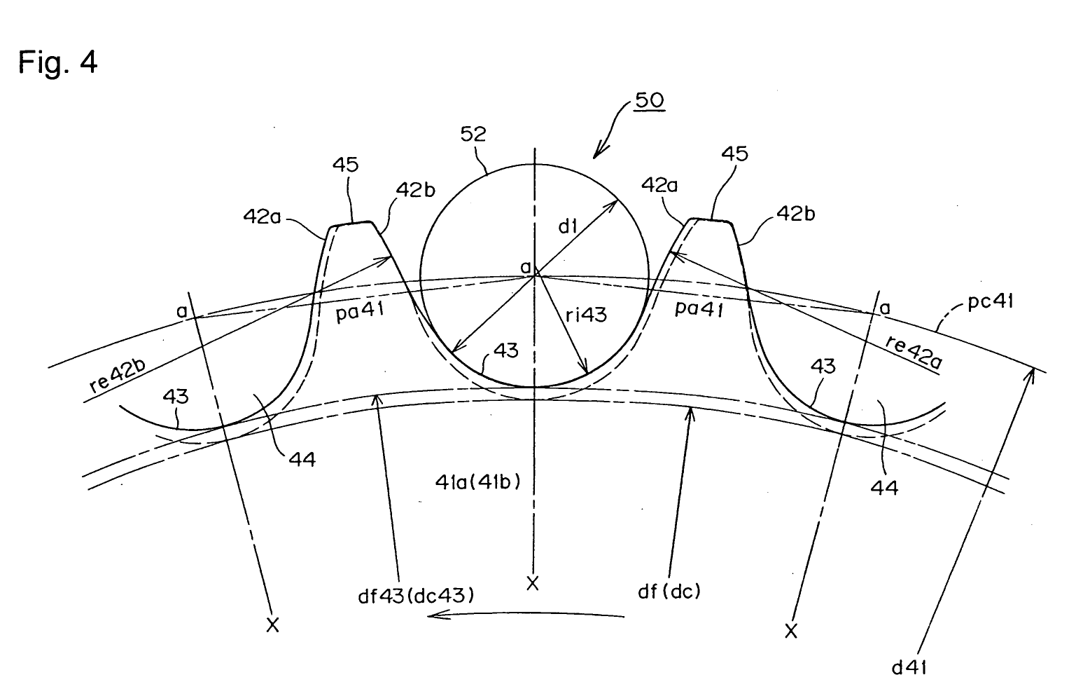

In a seventh example, the teeth 45 of a sprocket 41a have a tooth form as shown in FIG. 4. A tooth surface 42a, which is a front tooth surface with reference to the direction of rotation of the sprocket, and a rear tooth surface 42b, face each other across a tooth gap 44, and are continuous with a tooth gap bottom 43. The standard ISO tooth form is shown by a broken line for comparison.

The front tooth surface 42a and the rear tooth surface 42b are asymmetric with respect to the center line X of a tooth gap bottom. The tooth surface 42a is in the form of a convex arc. The arc forming the tooth surface 42a has a radius re42a, which is of a tooth surface larger than the radius re of the arc-shaped tooth surface of the standard ISO tooth form. That is, re42a>re. On the other hand, the arcuate, convex, rear tooth surface 42b has a radius re42b which is the same as the radius re of the arc shaped tooth surface of the standard ISO tooth form. That is, re42a=re. The tooth surface 42a and the tooth surface 42b are smoothly continuous with the tooth gap bottom 43.

The tooth gap bottom 43 is in the form of an arc having its center on the center line X of the tooth gap bottom. The arc of the tooth gap bottom 43 has a radius ri43, which is larger than the radius ri of the tooth gap bottom in a standard SO tooth form. That is, ri43>ri.

The center of the arc having radius ri43 is located radially outward with respect to the rotational center of the sprocket from the location of the center of the arc of the tooth gap bottom of the standard ISO tooth form. Therefore, the root diameter df43 is larger than the root diameter df of the Standard ISO tooth form. That is, df43>df. Furthermore, when the number of teeth 41a is odd, the caliper diameter dc43 is larger than the caliper diameter dc of the standard ISO tooth form. That is, dc43>dc.

Because the root diameter df43 is greater than the root diameter df of the standard ISO tooth form, the chordal pitch pa41 of the sprocket 41a (that is, the distance between intersections a of the pitch circle pc41 and the center lines X of the tooth gap bottoms) is greater than the chordal pitch pa of a standard sprocket. That is, pa41>pa.

Since a standard sprocket is adapted to the standard roller chain 50, the chordal pitch pa of a standard sprocket having a standard ISO tooth form is equal to the chain pitch p of a standard roller chain 50 (that is, the distance between the centers O1 of rollers 52). On the other hand, the chordal pitch pa41 of the sprocket 41a is larger than the chain pitch p of the standard roller chain 50. That is, pa41>p.

Furthermore, the tooth form pitch angles of the sprocket 41a according to the seventh example are the same as the tooth form pitch angles of the first example.

Referring again to FIG. 4, in an eighth example of the invention, the tooth form of the teeth of sprocket 41b is same as the tooth form of the seventh example. The pitch angles of the sprocket 41b, however, are the same as the tooth form pitch angles of the second example

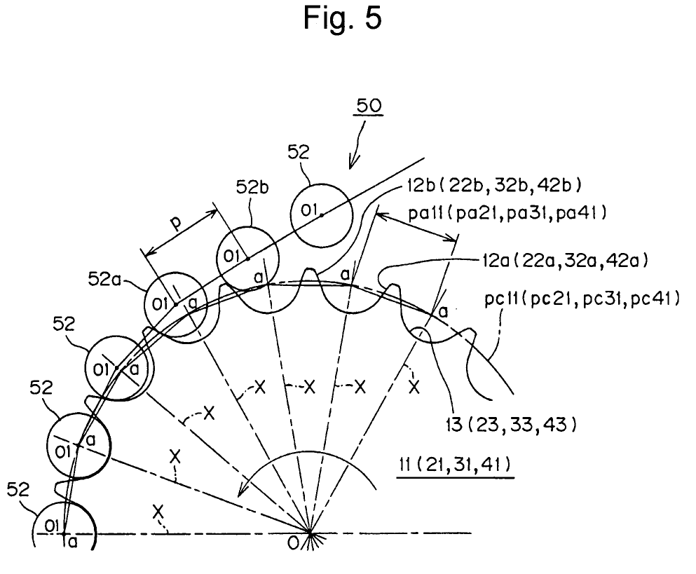

Sprocket teeth 11a, 11b, 21a, 21b, 31a, 31b, 41a and 41b engage a standard roller chain 50 in the same way, as illustrated in FIG. 5, which shows the engagement of a standard roller chain with a sprocket according to the invention in an internal combustion engine timing drive. The sprocket in FIG. 5 is used as an idler for changing the direction of travel of a timing chain for convenience in engine design.

When tension is applied to the standard roller chain 50 by rotation of a crankshaft, a roller 52 of the standard roller chain 50 sequentially engages a tooth groove of the sprocket, so that each sprocket rotates counterclockwise. When the sprocket is rotated counterclockwise, a roller 52b, which follows a roller 52a already engaged with the sprocket, pivots relative to the center O1 of roller 52a in an arc having a radius equal to the chain pitch p. Since the chordal pitch pall of the sprocket 11 is larger than the chain pitch p of the standard roller chain 50, the following roller 52b abuts a rear tooth surface 12b in a substantially tangential direction relative to the tooth surface 12b. As a result, the shock due to relative pivotal movement is small, and noise due to shock is reduced. As the sprocket rotates, the abutment position between the roller and the rear tooth surface moves to the tooth gap bottom 13. In the case of a roller chain, the movement of the roller to the tooth gap bottom 13 is substantially silent, as the movement of the roller takes place by a rolling action.

Although not illustrated, on disengagement from the sprocket, a preceding roller 52a pivots relative to a following roller 52b about the center O1 of the roller 52b in an arc having the chain pitch p as its radius. Since the preceding roller 52a only abuts on an abutment position of a front tooth surface, e.g. surface 12a, the roller can easily separate from the sprocket by a pivotal movement. The engagement of the standard roller chain 50 with sprockets 21, 31 and 41, and the disengagement of the chain from these sprockets, are similar to the engagement and disengagement in the case of sprocket 11 in examples 1 and 2.

The use of the sprockets 11, 21, 31 and 41 of the eight examples with a standard roller chain results in a reduction in overall noise and vibration. Since, in the tooth forms of the respective sprockets 11, 21, 31 and 41, the root diameters df13, df23, df33 and df43 are larger than the root diameter df of the standard sprocket having a standard ISO tooth form, the chordal pitches, pall, pa21, pa31 and pa41, of the respective sprockets 11, 21, 31 and 41 are larger than the chain pitch p of the standard roller chain 50. Thus, at the beginning of engagement, a roller first abuts back tooth surfaces 12b, 22b, 32b and 42b. The rollers abut the tooth surfaces 12b, 22b, 32b and 42b in a tangential direction, and, as a result there is only a small shock, if any, due to relative movement, and noises due to shock are significantly reduced.

At disengagement, a preceding roller 52a pivots relative to a following roller about the center of the following roller in an arc having a radius equal to the chain pitch p of the standard roller chain. Since a roller abuts a front tooth surface, e.g., 12a, 22a, 32a and 42a, it easily separates from the sprocket in a pivoting movement about the following roller. Therefore, disengagement the roller 52a takes place smoothly, without blockage as the conventional low noise chain transmission disclosed in Japanese Patent Publication NO. Hei. 7-18478.

In a chain transmission devices according to each of the eight examples of the invention, noise and vibration are also reduced by the irregular engagement times can be obtained. As apparent from FIGS. 6 and 7, the standard roller chain 50 has an equal chain pitch p, and the sprockets 11, 21, 31 and 41 can have two different sets of tooth form pitch angles. Since the tooth form pitch angles are arranged irregularly along the circumferential direction of the pitch circle pc, not only is the kinetic energy of the roller 52 imparted to tooth surfaces of the sprockets buffered, but the interval between abutments is varied. Thus, vibrations and noises having an order corresponding to the number of sprocket teeth are reduced. Furthermore, the difference between the overall sound magnitude and the magnitude of the rotational order sounds is large, and noise is effectively reduced.

Although, in each example of the invention described above a standard roller chain 50 is used the chain transmission according to the invention can be a standard bushing chain, in which bushings, instead of rollers, engage the sprocket teeth. Furthermore, although the examples described adopt tooth forms different from those of a standard sprocket, other tooth forms can be utilized and the same effects can be obtained, provided that the root diameter is larger than the root diameter of a standard sprocket. These same effects can be realized even if the tooth form shape, excluding the tooth gap bottom, is the same as that of the standard sprocket. The maximum outer diameter of the tooth forms in all eight examples maintains compatibility of the sprocket with a chain transmission using a conventional standard sprocket.

The invention reduces noise and vibration attributable to the engagement order, and at the same time reduces overall noises and vibrations. As a result, the invention has a synergistic effect in that it reduces the effective noise generated by the chain transmission by reason of a large difference between the overall sound and the sound of each rotational order.

What is claimed is:

1. A chain transmission comprising a standard roller chain or a standard rollerless bushing chain and a sprocket engageable in driving or driven relationship with the chain, in which the sprocket has at least two different tooth form pitch angles, said tooth form pitch angles are irregularly arranged along a circumferential direction of the sprocket's pitch circle, and in which the root diameter of the sprocket is larger than the root diameter of a standard sprocket designed for use with said standard chain.

2. A chain transmission according to claim 1, in which said tooth form pitch angles are θ−Δθ, θ−Δθ and θ+2Δθ, θ being the tooth form pitch angle of said standard sprocket, and said tooth form pitch angles are arranged irregularly along the circumferential direction of the sprocket's pitch circle.

3. A chain transmission according to claim 1, in which said tooth form pitch angles are θ−Δθ, θ, and θ+Δθ, θ being the tooth form pitch angle of said standard sprocket, and said tooth form pitch angles are arranged irregularly along the circumferential direction of the sprocket's pitch circle.
